(19) United States
(12) Patent Application Publication
(10) Pub. No.: US 2018/0124445 A1
(43) Pub. Date: May 3, 2018

(54) MASSIVE FILE AND DATA OBJECT REPLICATOR

(71) Applicant: IMAGINE COMMUNICATIONS CORP., North York (CA)

(72) Inventors: EDWARD BEILI, Givat Zeev (IL); Oren HENCINSKI, Holon (IL)

(21) Appl. No.: 15/338,928

(22) Filed: Oct. 31, 2016

(51) Int. Cl. H04N 21/274; H04N 21/218; H04N 7/173; H04N 21/235; H04N 21/84; H04L 29/08; H04N 21/222; H04N 21/231

(52) U.S. Cl. CPC H04N 21/274; H04N 21/2181; H04N 7/17318; H04N 21/23116; H04N 21/84; H04L 29/08549; H04N 21/222; H04N 21/2353

(57) ABSTRACT

Systems, devices and processes for massive file replication as described. A distributed file system has a distributed storage servers for storing private copies of shared media files. One or more replicators generate the replicas or private copies of media files. For example, the replicator reads a media file. The replicator creates a private copy of the media file in response to a replication request. The replication request specifies a convention for generating a reference for the private copy of the media file. The replicator writes the private copy of the media file to a storage server of the distributed storage servers. The replicator generates the reference for the copy of the media file based on the convention and the storage server. The replicator transmits metadata the distributed file system, the metadata indicating the reference for the copy of the media file.

### FIELD

The improvements generally relate to the field of digital video recording.

### INTRODUCTION

Remote Storage Digital Video Recording (RS-DVR) and Cloud-based Digital Video Recording (cDVR) require a highly-scalable and efficient file and data object replication function to create multiple private copies of shared video files in real time. In a cDVR implementation each incoming linear audio/video channel is transcoded into a single growing media file or a collection of short media files that represents a segmented audio/video asset suitable for media distribution over media information systems (e.g. Hypertext Transfer Protocol information systems). A typical segment length is a few seconds. This audio/video asset (either a single file or a collection of segments) can be kept in file storage, providing a convenient way to reference and play a media program transmitted on a particular channel in the past. However, legal requirements may require that each user requesting a recording or playout of a particular media program use only his/her own private copy of that media program. The private copy requirement attempts to mimic the behavior of a regular home DVR that records a private copy and plays the private copy out of a local storage. To satisfy this private copy requirement a cDVR implementation should be able to replicate a specific audio/video asset (a “shared” copy of the input program) into multiple private copies of the audio/video asset. That is, the cDVR implementation has a private copy for every subscriber which requests the recording of the program.

The amount of subscribers interested in the recording of a particularly popular TV program can reach into millions of subscribers. Contemporary High Definition video programming can require at least 10 Mbps of throughput per single program transcoded with multiple bitrates and multiple resolutions for multiscreen viewing. Future 4K and higher resolutions and proliferation of 3D viewing would only increase the required throughput. Multiplying it by millions of cDVR subscribers makes this massive file replication task difficult.

### SUMMARY

In accordance with one aspect, there is provided a file storage device with a distributed file system configured to write a media file to a storage server, and a processor. The processor is configured to: transmit, to a replicator, a replication request to create a plurality of copies of the media file, the replication request specifying a convention for generating a reference for a copy of the media file of the plurality of copies of the media file; receive, from the replicator, metadata indicating the reference for the copy of the media file, the reference identifying a storage server of a plurality of distributed storage servers; read the copy of the media file from the storage server using the reference for the copy of the media file; and transmit the copy of the media file to a user device for playout.

In some embodiments, the file storage device has a load balancer configured to monitor a plurality of replication requests and distribute the plurality of replication requests among a plurality of replicators to generate the plurality of copies of the media file.

In some embodiments, the processor is part of a central processing unit local to the distributed file system.

In some embodiments, the replicator is at the storage server of the set of distributed storage servers.

In some embodiments, the media file comprises a plurality of file segments and wherein the replicator creates a plurality of copies of the plurality of file segments to create the plurality of copies of the media file.

In some embodiments, the media file comprises a plurality of file segments, and wherein the processor is configured to create the plurality of copies of the media file by transmitting the replication request to a first replicator to create a plurality of copies of a first file segment and a second replicator to create a plurality of copies of a second file segment.

In accordance with another aspect, there is provided a file storage device having a processor configuring a replicator to read a media file from a distributed file system. The replicator creates a plurality of copies of the media file in response to a replication request, the replication request specifying a convention for generating a reference for a copy of the media file of the plurality of copies of the media file. The replicator writes the copy of the media file to a storage server of a plurality of distributed storage servers. The replicator generates the reference for the copy of the media file based on the convention and the storage server. The replicator transmits metadata the distributed file system, the metadata indicating the reference for the copy of the media file.

In some embodiments, the processor configures a plurality of replicators and a load balancer, the load balancer configured to monitor a plurality of replication requests and distribute the plurality of replication requests among the plurality of replicators.

In some embodiments, the processor is part of a central processing unit local to the storage server.

In some embodiments, the processor a microprocessor of a media controller for the storage server.

In some embodiments, the media file comprises a plurality of file segments and wherein the replicator creates a plurality of copies of the plurality of file segments to create the plurality of copies of the media file.

In some embodiments, the media file comprises a plurality of file segments and the processor configures a first replicator to create a plurality of copies of a first file segment and a second replicator to create a plurality of copies of a second file segment.

In some embodiments, the replicator generates the metadata indicating the reference for each of the plurality of copies of the media file based on the convention specified in the replication request.

In accordance with another aspect, there is provided a method for file storage that involves: reading a media file from a distributed file system; creating a plurality of copies of the media file in response to a replication request, the replication request specifying a convention for generating a reference for each of the plurality of copies of the media file; writing the plurality of copies of the media file to a plurality of distributed storage servers; generating metadata indicating the reference for each of the plurality of copies of the media file based on the convention specified in the replication request and the plurality of distributed storage servers; and transmitting the metadata to the distributed file system.

In some embodiments, reading the media file from the distributed file system involves reading a plurality of file segments of the media file and wherein creating a plurality of copies of the media file comprises creating a plurality of copies of the plurality of file segments.

In some embodiments, the method involves monitoring a plurality of replication requests and distributing the plurality of replication requests among the plurality of replicators.

In some embodiments, the method involves reading the media file from the distributed file system comprises reading a plurality of file segments of the media file and wherein creating a plurality of copies of the media file comprises creating a plurality of copies of a first file segment using a first replicator and creating a plurality of copies of a second file segment using a second replicator.

In some embodiments, the method involves transmitting a copy of the media file from the storage server using the reference for the respective copy of the media file.

In some embodiments, the method involves transmitting a replication request to create the plurality of copies of the media file.

In some embodiments, the method involves reading a copy of the media file using the reference for the respective copy of the media file.

Many further features and combinations thereof concerning embodiments described herein will appear to those skilled in the art following a reading of the instant disclosure.

### DESCRIPTION OF THE FIGURES

Embodiments will now be described, by way of example only, with reference to the attached figures, wherein in the figures:

FIG. 1 is a schematic diagram of an example media storage system according to some embodiments;

FIG. 2 is a schematic diagram of another example media storage system according to some embodiments;

FIG. 3 is a schematic diagram of a further example media storage system according to some embodiments;

FIG. 4 is a flowchart diagram of a method for media storage according to some embodiments;

FIG. 5 is a flowchart diagram of another method for media storage according to some embodiments;

FIG. 6 is a schematic diagram of components for implementing aspects of an example media storage system according to some embodiments; and

FIG. 7 is a schematic diagram of components for implementing aspects of an example media storage system according to some embodiments.

### DETAILED DESCRIPTION

Embodiments described herein relate to digital video recording and massive file and data object replication.

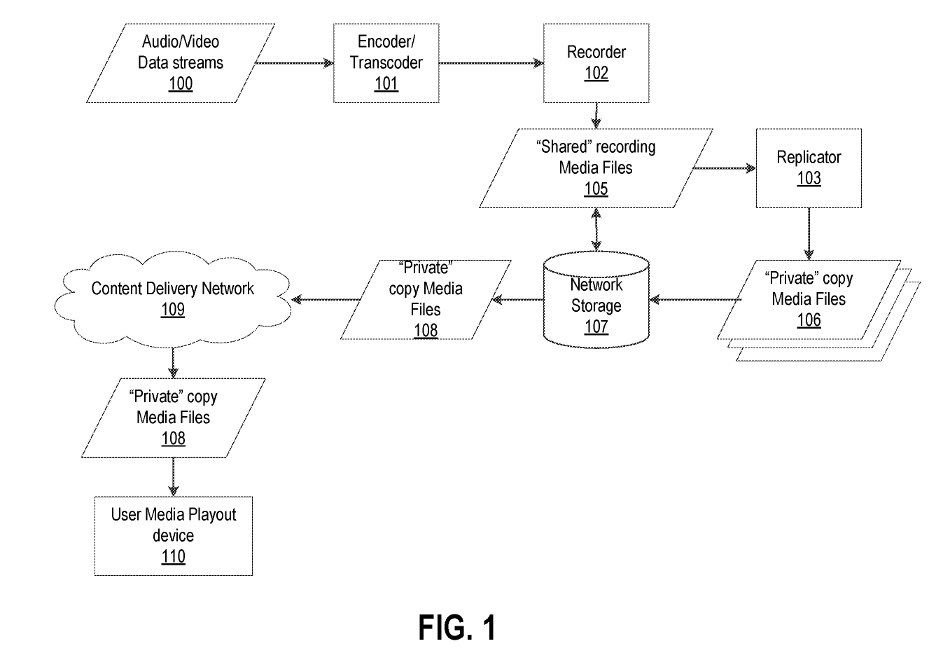

FIG. 1 is a schematic diagram of an example media storage system according to some embodiments. An encoder and transcoder 101 processes audio and video data streams 100 to generate media files 105. A recorder 102 stores a shared copy of the media files 105 on network storage 107. A replicator 103 makes private copies of the media files 106 in response to copy requests from users. The private copies of the media files 106 are also stored on network storage 107. User media playout device 110 requests playout of a private copy of a media file 108. The private copy of the media file 108 is distributed from the network storage 107 to the user media playout device 110 over content delivery network 109.

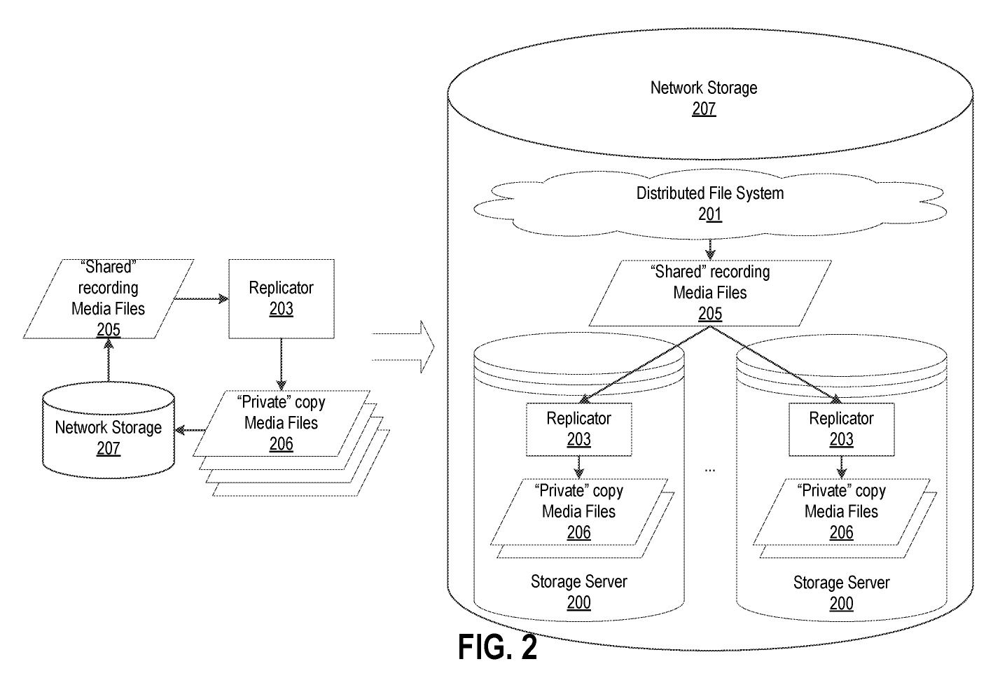

FIG. 2 is a schematic diagram of an example media storage system according to some embodiments. The replicator 203 interacts with network storage 207 to make private copies of media files 206. The replicator 203 may generally correspond to replicator 103 of FIG. 1. Network storage 207 may generally correspond to network storage 107 of FIG. 1. The private copies of the media files 206 may generally correspond to the private copies of the media files 106 of FIG. 1.

The media storage system includes a DFS 201 on network storage server 207 having multiple storage servers 200. The media storage system implements RS-DVR or cDVR functionality by storing private copies of the media files 206 on storage servers 200. The DFS 201 manages the storage and retrieval of the private copies of the media files 206 on storage servers 200, A cDVR solution enables the recording of a media file in a network storage server 207 (e.g. cloud), rather than on a home set-top box, for example.

File replication over a DFS 201 can be subject to a write throughput bottleneck of the DFS 201 network, for example. In an aspect, embodiments described herein provide a scalable cDVR or RS-DVR solution that may be compliant with a private copy requirement for media files. The required write throughput grows linearly with the amount of peak simultaneous private copies, which usually is a percentage of the total number of the subscribers interested in the media file.

The DFS 201 is configured to write private copies 206 of media files 205 to distributed storage servers 200. The DFS 201 manages file and object metadata for the private copies 206 of the media files 205. The DFS 201 transmits, to a replicator 203, a replication request to create a private copy 206 of a shared recording media file 205. The replication request specifies a convention for generating a reference for the private copy 206 of the shared recording media file 205. The DFS 201 receives, from the replicator 203, metadata indicating the reference for the private copy 206 of the shared recording media file 205. The reference identifies the storage server 200 of the plurality of distributed storage servers 200 that stores the private copy 206. The DFS 201 updates file and object metadata with the metadata indicating the reference for the private copy 206 of the media file 205. In response to a playout request, the DFS 201 reads the private copy 206 of the media file 205 from the storage server 200 using the reference of the file and object metadata. The DFS 201 transmits the private copy of the media file to a user device 110 for playout.

The DFS 201 implements load balancing to distribute multiple replication requests amongst multiple replicators 203. The DFS 201 has a load balancer configured to monitor replication requests and workload of the replicators 203. The load balancer distributes the replication requests among the replicators to generate the private copies 206 of the media files 205.

The shared recording media file 205 can be made of file segments. The replicator 203 creates a copy of each of the file segments to create the private copy 206 of the media file 206. For example, the media file 205 can include a first file segment and a second file segment. The DFS 201 is configured to create the private copy 206 of the media file 205 by transmitting the replication request to a first replicator 203 to create a first copy of the first file segment and a second replicator 203 to create a second copy of the second file segment. The private copy 206 includes the copies of the first and second file segments. The first and second file segments may be stored on the same or different storage servers 200.

The replicator 203 is configured to read a shared recording media file 205 and create a private copy 206 of the media file 205 in response to a replication request. The replication request specifies a convention for generating a reference for the private copy 206 of the media file 205. The replicator 203 is configured to write the private copy 206 of the media file 205 to a storage server 200 of distributed storage servers 200 of the DFS 201. The replicator 203 is configured to generate the reference for the private copy 206 of the media file 205 based on the convention and the storage server 200 storing the private copies. The replicator 203 is configured to transmit metadata to the DFS 201. The metadata indicates the reference for the private copy 206 of the media file 205.

As shown, there may be multiple replicators 203. For example, a first replicator writes a copy of a first file segment to a first storage server 200 and a second replicator 203 writes a copy of the second file segment to a second storage server 200 of the distributed storage servers. The copies of the first and second file segments form part of the private copy 206 of the media file 205. The first replicator 203 generates the metadata indicating the reference for the copy of the first file segment on the storage server 200 and the second replicator generates the metadata indicating the reference for the copy of the second file segment on the additional storage server 200.

Network storage 207 can include multiple distributed storage servers 200 connected by a network, which may be referred to as a distributed storage system. A distributed storage system handles a sufficiently large number of subscribers but is constrained by the network speed (as compared to media speed) from the network connecting the storage servers 200. The write throughput of the available storage servers 200 does not grow linearly with the amount of storage servers 200. Instead the write throughput plateaus at several gigabits per second (GB/s) and even goes down as the amount of storage servers grows. Embodiments described herein include one or more replicators 203 configured to replicate or generate private copies of the media files 206 at individual storage servers 200 to alleviate the network and DFS 201 write throughput bottlenecks and providing linear scalability.

In an example cDVR implementation each incoming linear audio/video channel (e.g. audio/video stream 100) is transcoded into a single growing shared recording media file 105 or a collection of short media files 105. The media files 105 represent a segmented audio/video asset, with a typical segment length of a few seconds, suitable for media distribution over a content distribution network (CDN) 109. The audio/video asset (either a single media file or a collection of segments) can be stored at DFS 201 or storage server 200 to provide a convenient way to reference and play any media program transmitted on a particular channel in the past. However, legal requirements may indicate that each user requesting a recording/playout of a particular video program use only his/her own private copy 206 of that program. This private copy requirement attempts to mimic the behavior of a regular home DVR, recording and playing out of a local storage. To satisfy this private copy requirement the media storage system is able to replicate a specific media file 205 or asset (a “shared” copy of an input program from the audio/video data stream 100) into multiple private copies 206 of the media asset. There can be a private copy media file 206 of the asset for every subscriber that requests the recording of the shared media program file 205.

There may be many subscribers interested in recording a popular media program. Higher media resolutions and proliferation of multi-dimensional viewing increase the required throughput. Millions of cDVR subscribers make this massive file replication task non-trivial.

An example implementation of the file replication involves making the required number of copies by repeatedly calling a regular copy program. The copy program opens the source file and the destination file and copies the media file data by reading the data blocks from the source file and writing the data blocks to the destination file. The copy program can use different file system application programming interfaces (API), like POSIX or RESTfull for file or object storage. Another example implementation involves reading the source file or object only once into a shared buffer and writing the replicas in parallel, to fully utilize the file system and object storage write throughput.

For an implementation that scales to a multi-server storage system using a DFS 201 (with object storage), the speed of the interconnecting network becomes a limiting factor. The network can be slower than the maximum throughput speed supported by the media.

Embodiments described herein provide a media storage system that implements highly-scalable and efficient file/data object replication function and creates multiple private copies of media files 206 from shared media files 205 of an audio/video data stream 100 in real time.

The audio/video data stream 100 can include a particular TV channel, video or other type of media. The encoder/transcoder 101 continuously encodes, transcodes, packages media files 105 from the audio/video data stream 100. The recorder 102 periodically writes audio, video and associated metadata segments of the media file 205 into the DFS 201 running on top of the storage server 207. In some embodiments, the network storage 207 includes multiple storage servers 200. Network storage 207 can include distributed storage servers 200 connected by a network.

User media playout device 110 includes an application that transmits control data to record a particular shared media file 205 of the audio/video data stream 100. The control data includes a replication request for the media file 205 to trigger replication or recording of a private copy of the media file 206. User media playout device 110 can interface with a digital right management (DRM) server to ensure the replication request complies with digital rights for the asset. User media playout device 110 is operable to register and authenticate users (using a login, unique identifier, and password for example). User media playout device 110 may serve one user or multiple users.

The DFS 201 generates one or more private copies 206 of the shared media file 205 using replicator 203. Storage server 200 stores the private copies 206 of the shared media file 205. User media playout device 110 transmits control data to request playback of the private copy of the media file 206. A copy of media file 206 is read from storage server 207 and transmitted to user device 110 over the CDN 109 for playback. The CDN 109 connects the DFS 201 to other components in various ways including directly coupled and indirectly coupled via various types of networks. CDN 109 is capable of carrying data including audio/video data and control data.

In an aspect, embodiments described herein provide a scalable solution that involves replicators 203 and distributed storage servers 200. The replicator 203 can be integrated with storage server 200 in some example embodiments. There can be multiple replicators 203 in some example embodiments for load balancing a large number of replication requests.

A replicator 203 replicates or generates copies of the media file in response to replication requests. In some embodiments, the replicator 203 generates copies of the media file (e.g. replication) at the DFS 201 or storage servers 200 that stores the copies of the media file. For example, in some embodiments, the local central processing unit (CPU) of the storage servers 200 configures the replicator 203. In some embodiments, a microprocessor in a media controller configures the replicator 203. In other embodiments, the replicator 203 runs below the DFS 201 or as part of the DFS 201.

The DFS 201 is configured to write media files 205 output by recorder 102 and transcoder 101 from the audio video data stream 100. A shared media file 205 can include one or more segments. The DVR device 106 transmits to the replicator 203 a replication request to create replicas or copies of a media file 205. The replication request specifies a convention for generating a reference for a replica or private copy of the media file 206. The replicator 203 generates the replica or copy of the media file. If the shared media file 205 is made up of segments then the replicator 203 creates private copies of the segments to create the replica or private copy of the media file 206. The replica or private copy of the media file 206 is stored at storage server 207. The DFS 201 receives, from the replicator 203, metadata indicating the reference for the private copy of the media file 206. The reference identifies the storage server 200 (of the distributed storage servers) that stores the media file or segments thereof. In some embodiments, one replicator 203 creates a private copy 206 of a first file segment and another replicator 203 creates a private copy 206 of a second file segment. In some embodiments, the DFS 201 can aggregate segments of the private copy of the media file 206 from different storage servers 200.

User media playout device 110 transmits a request to playout the replica 206 (e.g. private copy of the media file 206) or otherwise instructs the CDN 109 to serve the replica media file 206 available via the DFS 201 and storage server 207 for playout. The DFS 201 reads the replica or private copy of the media file 206 from the storage server 200 using the reference for the private copy of the media file 206. The DFS 201 transmits the copy of the media file to the user media playout device 110 for playout.

In some embodiments, DFS 201 includes a load balancer configured to monitor replication requests and replication statistics. The load balancer distributes the replication requests among multiple replicators 203 to generate the private copies of the media file 206 from the shared media file 205.

An API procedure is provided for components to instruct the replicator 293 to create a number of private copies 206 of an existing media file 205 and object. The API specifies a convention for referencing (naming) each private copy of the media file 206. In some example embodiments, a replication request is generated using the API which includes a convention for generating a reference for a private copy of the media file 206. The reference indicates a name for the private copy of the media file 206 and the stored location of the private copy of the media file 206 (e.g. the location can be one or more storage servers 200). An API procedure is provided to update the DFS 201 with the new metadata about references to newly created private copies of the media file 206. Private copies of the media file 206 can be referred to here as replicas. The API procedure is invoked by the replicator 203 once the replication is completed, so that the new replicas 206 are available to any top-level application via regular file and object access APIs.

In response to a replication request, the replicator 203 reads a media file 205 or segment thereof from the DFS 201 and creates a replica or private copy of the media file 206 or segment thereof. The replicator 203 writes the replica or private copy of the media file 206 or segment to a storage server 200. The replicator 203 generates a reference for the private copy of the media file 206 based on the convention of the replication request and the storage server 200. The replicator 203 transmits metadata the DFS 201 that indicates the reference for the private copy of the media file 206. The replicator 203 can create private copies of segments of the media file to create private copies of the media file 206.

Embodiments described herein implement the replicator 203 (e.g. replication task) at a local server storage 200 or the DFS 201 (which also includes storage components) as close to the shared media file 205 as possible to eliminate the network bottleneck, increasing the replication speed linearly with the number of storage servers 200. The replicator 203 is implemented by a processor controlled by instructions for the replication of shared media files 205 (generating private copies of media files 206 or replicas).

In some embodiments, the replicator 203 can be located at the local CPU of a storage server 200 or the microprocessor in the media controller. In other embodiments, the replicator 203 can be a part of any device implementing the DFS 201 (with object storage). In further embodiments, the replicator 203 can be run at a lower layer, if minimal changes to the DFS 201 are required. The replicator 203 updates the DFS 201 with metadata indicating the information about the newly made private copies of the media files 206 once the copies are made. The metadata includes the references for the private copies of the media files 206. The private copies of the media files 206 are available to the top-level application (e.g. cDVR) via regular access to DFS 201 and the metadata.

Embodiments described herein implement massive object replication using a low level replicator 203, running at each storage server 200, below the DFS 201. The replicators 120 are instructed using a set of APIs. The set of APIs include various functions or procedures to generate commands and instructions between components, including the following examples procedures.

In some embodiments, the set of APIs includes a procedure, invoked by the top level application on the reception of a bulk request, to instruct the replicator 203 to create a number of private copies 206 (replicas) of an existing file/object using a replication request. The replication request specifies a convention for referencing (naming) each replica 206. An example replica referencing convention can be appending the ID of a customer making a recording request to the original video segment name or an identifier for the user media playout device 110.

In some embodiments, the set of APIs includes a procedure to update the DFS 201 with the new metadata about the newly created private copies 206. This procedure can be invoked by the replicator 203 once the replication is completed to provide metadata to the DFS 201 for the private copies of the media files 206.

In some embodiments, the set of APIs includes a procedure for providing individual replicator 203 statistics that can be used to help in load balancing the replication requests among multiple replicators 200 and storage servers 200. Accordingly, DFS 201 implements load balancing by distributing replication requests among multiple replicators 203 and storage servers 200 for making and storing the private copies 206.

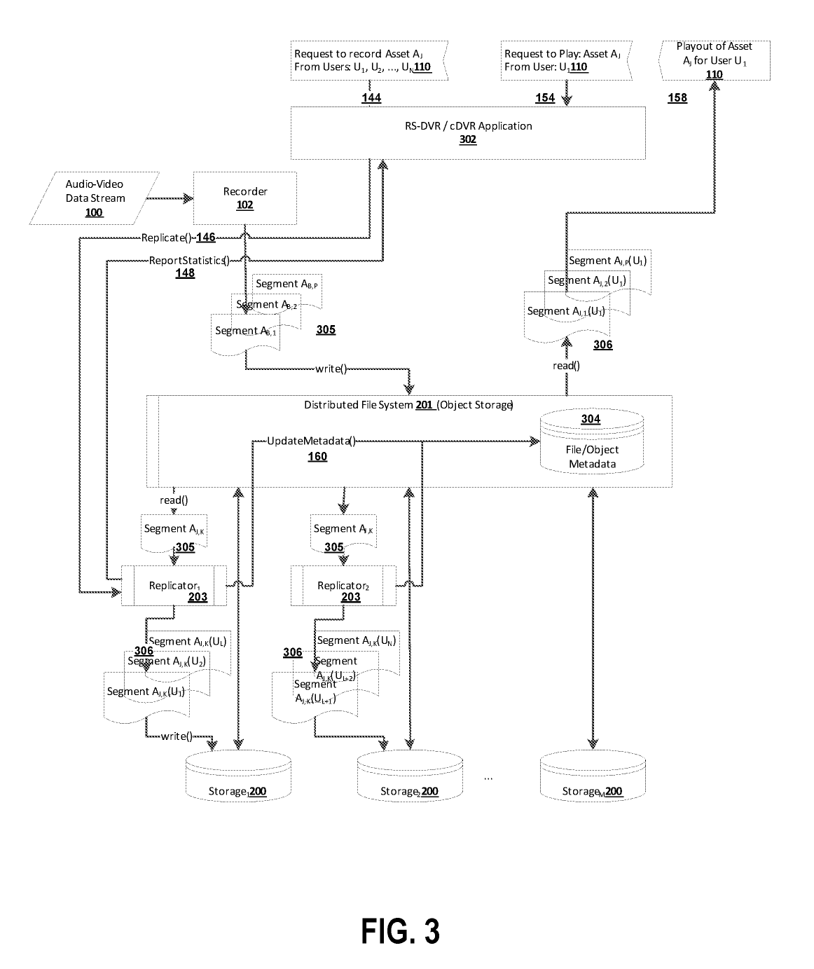

FIG. 3 is a schematic diagram of a further example media storage system according to some embodiments.

An audio video data stream 100 can represent a particular TV channel by way of illustrative example. The audio video data stream 100 is being continuously recorded by a recorder 102 (and encoded by transcoder 101). The recorder 102 periodically writes the audio video segments 305 and associated metadata 304 into the DFS 201 (with Object Storage). The DFS 201 runs on top of a number of distributed storage servers 200.

For the audio video segments 305 the notation A_{B} denotes a particular asset B (e.g. one or more shared media files 205). An asset is a collection of media files 205 and objects representing a TV program, video, audio or other media program. The asset may possibly have a plurality of encodings for different resolutions and bitrates by encoder 101. Notation A_{B,P} represents a sequential time segment 305 with index P of a particular asset B. The length of a segment 305 can be set to 10 seconds for example. The first segment 305 A_{B,1} will be written to the DFS 201 approximately 10 seconds after the beginning of the program B, the second segment 305 A_{B,2} will be written in 20 seconds and so on. The DFS 201 stores the segment 305 and updates the File/Object Metadata Database 304. Once the segment 305 is stored in the DFS 201 the segment 305 becomes available to all applications with sufficient permissions to be read, renamed, copied, deleted and so on.

A RS-DVR/cDVR application 302 with instructions to execute recording functionality. DVR application 302 receives multiple replication requests 144 from individual users or subscribers devices 110. The DVR application 302 sends the replication requests 144 and replication commands 146 to replicator(s) 203. In some embodiments, for efficiency purposes the cDVR application 302, or some higher level middleware, lumps together multiple recording requests for the same asset A_{J} into a single bulk request 144 and replication command 146. The bulk request 144 and replication command 146 list the media asset 305 to record and all the user device 110 who requested such recording (the users being denoted as U₂, U₂, and so on). The bulk request 144 and replication command 146 can be split into smaller sub replication requests 144 and commands 146 destined to individual replicators 203 running on each storage server 200, to prevent overloading of the replicators 203. For example, the bulk replication request 144 and replication command 146 for asset A_{J} from user device 110 U₁, U₂, . . . , U_{N} is split into a sub replication request (involving API procedure Replicate( ) to generate command 146) for users U₁, U₂, . . . , U_{L}, and sent to Replicator₁, 203 running on Storage₁, server 200. Another sub replication request 144 and command 146 for users U_{L+1}, U_{L+2}, . . . , U_{N}, is sent to Replicator₂ 203 running on Storage₂ 200. The replicator 203 reports back its performance statistics via API procedure message ReportStatistics( ) 148 to provide the cDRV application 302 with information about the replicator's 203 load and/or available capacity.

The cDRV application 302 sends the replication requests 144 to replicator(s) 203 via the API procedure Replicate( ) to generate commands 146 in order to instruct the replicator 203 to replicate an asset or a particular segment. The replicator 203 reads a “shared” segment 305 previously recorded by the recorder 102 in DFS 201. For example, the replicator 203 reads segment A_{J,K} 305, and makes a unique “private” copy or replica 306 of the segment A_{J,K} 305 for each user, for example replica A_{J,K}(U₁) 152 for user U₁, replica A_{J,K}(U₂) 152 for user U₁, and so on. The replicator 203 stores the replicas 306 on a local storage server 200 in some embodiments. Once the private copy or copies (replicas) 306 are made, the replicator 203 updates the file/object metadata in the File/Object Metadata Database 304 of the DFS 201, via API procedure UpdateMetadata( ) 160. The newly created private copies or replicas 306 can be made available to all applications, just like the original shared copy 305 or segment thereof.

A user U₁ triggers a playout request 154 to play a previously recorded “private” asset A_{J} 306 at user device 110. The user device 110 (via the cDVR application 302) instructs the CDN 109 (FIG. 1) to serve the user private copy segments A_{J,1}(U₁), A_{J,2}(U₁) , . . . , A_{J,P}(U₁) 306 available via DFS 201, for the playout 158 at user device 110. The user device 110 transmits a playout request 154 to DFS 201, for example. In response the DFS 201 serves the user private copy segments A_{J,1}(U₁), A_{J,2}(U₁) , . . . , A_{J,P}(U₁) 306 for playout 158 at user device 110. The user private copy segments A_{J,1}(U₁), A_{J,2}(U₁) , . . . , A_{J,P}(U₁) 306 can be replicas stored in storage server(s) 200 and accessible by DFS 201 using the metadata and references stored in the File/Object Metadata Database 304.

In an aspect, embodiments described herein implement file replication using a replicator 203 that is located as close to the segments of the shared media file 305 as possible, e.g. at the storage server 200 storing the segments of the media file 305. For example, the replicator 203 can be implemented by the local CPU of the storage server 200, or even by the microprocessor in a media controller. In some embodiments, the replicator 203 runs below the DFS 201 or as part of the DFS 201.

In an aspect, embodiments described herein provide an API to generate and transmit instructions for the replicator 203. For example, the API can be used by components to generate and transmit instructions or a replication request for the replicator 203 to create a number of private copies (replica segments 305) of an existing shared media file/object (or segment 305 thereof). The replication request 144 can specify a convention for referencing (naming) each replica segment 305. As another example, the API can be used by components to generate and transmit instructions to update the DFS 201 with the new metadata about the newly created replicas segments 305. The API procedure can be invoked by the replicator 203 once the replication is completed, so that the new replicas 206 (or segments 305) are available to any top-level application via regular file/object access APIs. For example, DVR application 302 can request DFS 201 to playout 158 a private copy or replica segment 305 of a media asset (or multiple). As a further example, the API can be used by components to indicate individual replicator 203 statistics to help for load balancing the replication requests among the replicators 203.

In some embodiments, the DVR application 302 is configured for load balancing to distribute replication requests across multiple replicators 302. The DVR application 302 can use feedback data from replicators 203 and DFS 201 including the reported statistics for load balancing. The load balancing can maximize replication throughput, minimize replica creation time and avoid replicator 203 overload.

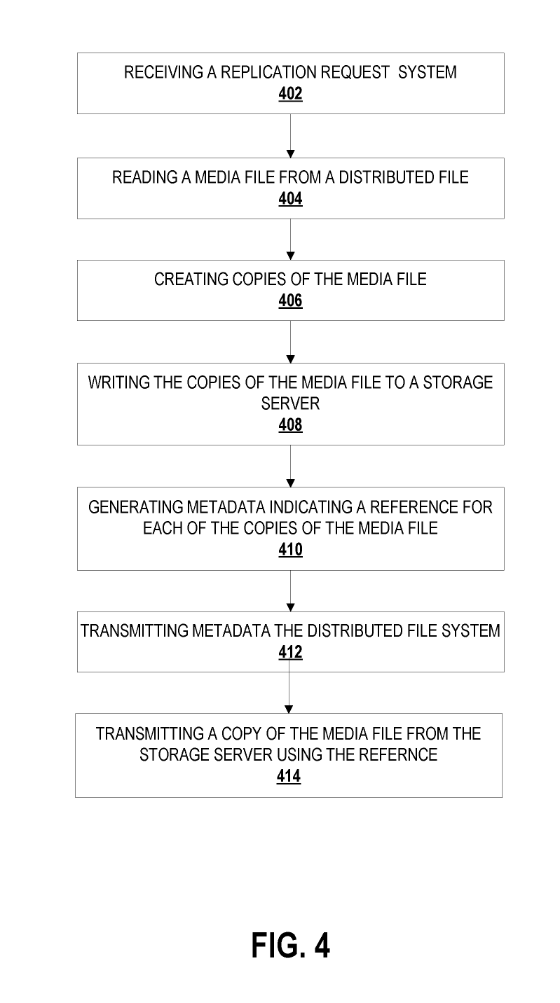

FIG. 4 is a flowchart diagram of a method for media storage according to some embodiments.

At 402, a replicator 203 receives a replication request from a cDVR application 302. The cDVR application generates and transmits replication requests in response to user commands. The cDVR application 302 can implement load balancing to route replication requests to different replicators 203 depending on capacity, availability, and replication statistics. The cDVR application 302 (or replicator 203) can monitor replication requests and distributing the replication requests among multiple replicators 203.

At 404, a replicator 203 reads a media file segment 305 (or entire media file 205) from the DFS 201 or storage server 200 storing the media file segment 305. In some embodiments, the replicator 203 reads the entire media file 205 from the DFS 201.

At 406, the replicator 203 creates a replication or private copy 206 of the media file 205 in response to a replication request. The replicator 203 can create the replica or private copy 206 of the media file by generating private copy segments 306 of shared media file segments 305 of the media file. The replication request specifies a convention for generating a reference for the replica or private copy of the media file 206 (or private copy segments 306). The replication request can also identify the requesting user device 110.

At 408, the replicator 203 writes the replica or private copy of the media file 206 to a storage server 200 of distributed storage servers 200 for the network storage 207. The replicator 203 can write copies of segments 306 of the replica or private copy 206 of the shared media file 205 to the storage server 207, for example. The replicator 203 can write copies of segments 306 of the replica or private copy 206 of the media file to different storage servers 200, as another example.

At 410, the replicator 203 generates metadata indicating the reference for the replica or copy of the media file based on the convention specified in the replication request and the storage server(s) 200 storing the replica 206 or replica segments 306. The metadata can also include data identifying the requesting user device 110.

At 412, the replicator 203 transmits the metadata to the DFS 201 for storage in the metadata object database 304.

At 414, the DFS 201 transmits the replica or a private copy 206 of the media file (or segments 306) from the storage server 200 using the reference for the private copy 206 of the media file (or reference for the private copy segments 306). The DFS 201 can read the replica 206 or private copy of the media file using the reference for the respective copy of the media file 206. The DFS 201 transmits the replica 206 or a private copy of the media file to a user device 110 for playout. The user device 110 can be web-enabled computing device, a mobile computing device, a television, and so on.

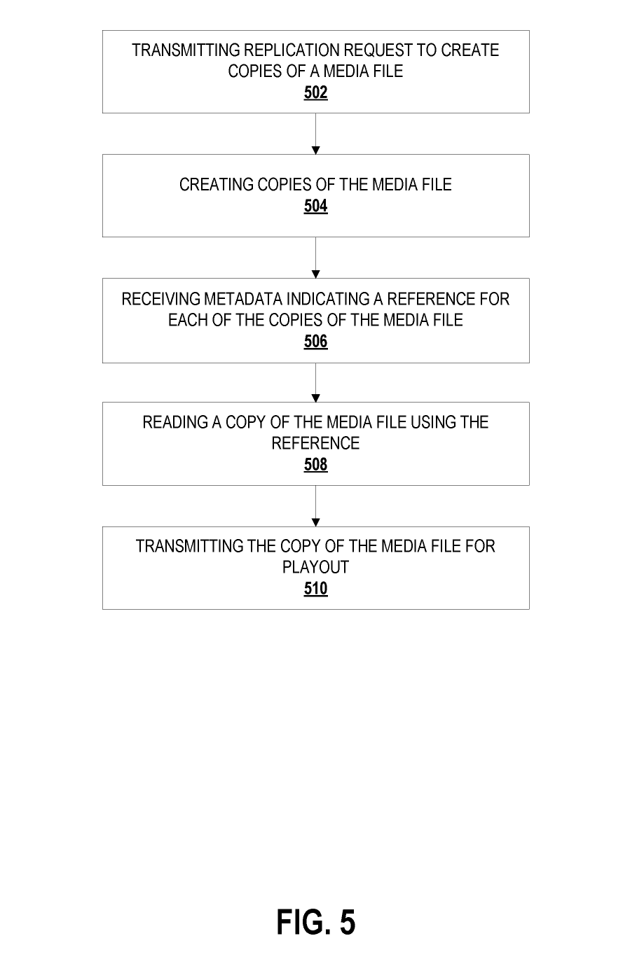

FIG. 5 is a flowchart diagram of another method for media storage according to some embodiments.

At 502, the user device 110 transmits, to the replicator 203, a replication request to create a replica or a private copy of the media file 206. The replication request specifies a convention for generating a reference for the replica or private copy of the media file 206. The replication request can also indicate the media file to generate a copy of, the user device 110 requesting the private copy 206 or the DFS 201 storing the shared media file 205, for example. The user device 110 can interface with a DRM server to ensure the replication request complies with digital rights for the asset.

At 504, the replicator 203 creates the replica or private copy 206 of the shared media file 205 in response to the replication request. The replicator 203 can create copies of segments 305 of the media file to create the replica segments 306, for example. The replicator 203 can read the media file 205 or segments 305 thereof from the DFS 201 to generate the replica 206 or private copy segments 306 of the shared media file 205.

At 506, the DFS 201 receives, from the replicator 203, metadata indicating the reference for the copy 206 of the media file. The reference can also identify a storage server 200 that stores the replica or private copy 206 of the media file. Multiple storage servers 200 may store different private copy segments 306 of a private copy 306. The reference can identify the storage servers 200. The metadata can also identify the user device 110 requesting the private copy 206.

At 508, the DFS 201 reads the replica or private copy 206 of the media file from the storage server 200 using the reference for the copy 206 of the media file. The DFS 201 may receive a playout request from user device 110 to trigger reading of the replica or private copy of the media file 206.

At 510, the DFS 201 transmits the private copy of the media file 206 to the user device 110 for playout.

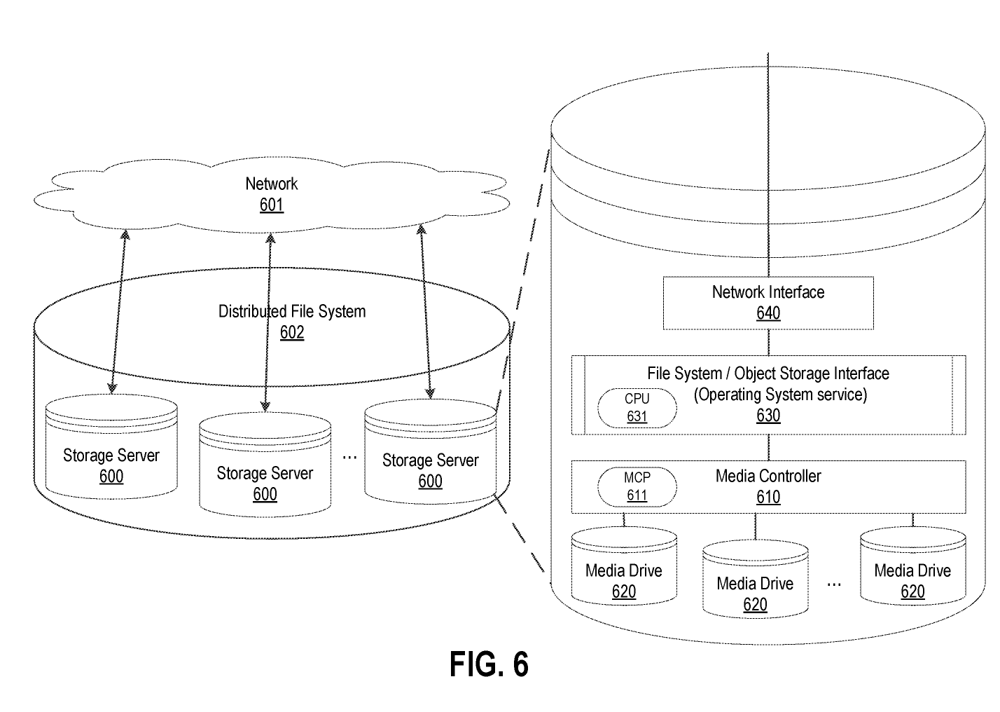

FIG. 6 is a schematic diagram of computing components that can implement aspects of DFS 602 according to some embodiments. The DFS 602 shown in FIG. 6 may generally correspond to DFS 201 of FIG. 2. The DFS 602 connects to network 601 to read and transmit media files (including shared media files 205 and private copies 206). The DFS 602 includes multiple storage servers 600. The storage servers may generally correspond to storage servers 200 of FIG. 2. Each storage server 200 can include a network interface 640, a central processing unit (CPU) 631, a media control platform (MCP) 611, and media drives 620. The CPU 631 includes a file system and object storage interface 630 which is an operating system service. The file system and object storage interface 630 is a storage architecture that manages data as a file hierarchy and block storage which manages data as blocks within sectors and tracks, as well as managing data as objects. The file system and object storage interface 630 can generate and manage file and object metadata 304 for the media files 205, private copies 206, segments of media files 305, and segments of private copies 306. The MCP 611 includes a media controller 610 that locates and transmits media data (e.g. media files 205, private copies 206, segments of media files 305, and segments of private copies 306). The network interface 640 enables storage server 600 to communicate with other components, to exchange data with other components, and to access and connect to network resources.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

Various example embodiments are described herein. Although each embodiment represents a single combination of inventive elements, all possible combinations of the disclosed elements include the inventive subject matter. Thus if one embodiment comprises elements A, B, and C, and a second embodiment comprises elements B and D, then the inventive subject matter is also considered to include other remaining combinations of A, B, C, or D, even if not explicitly disclosed.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

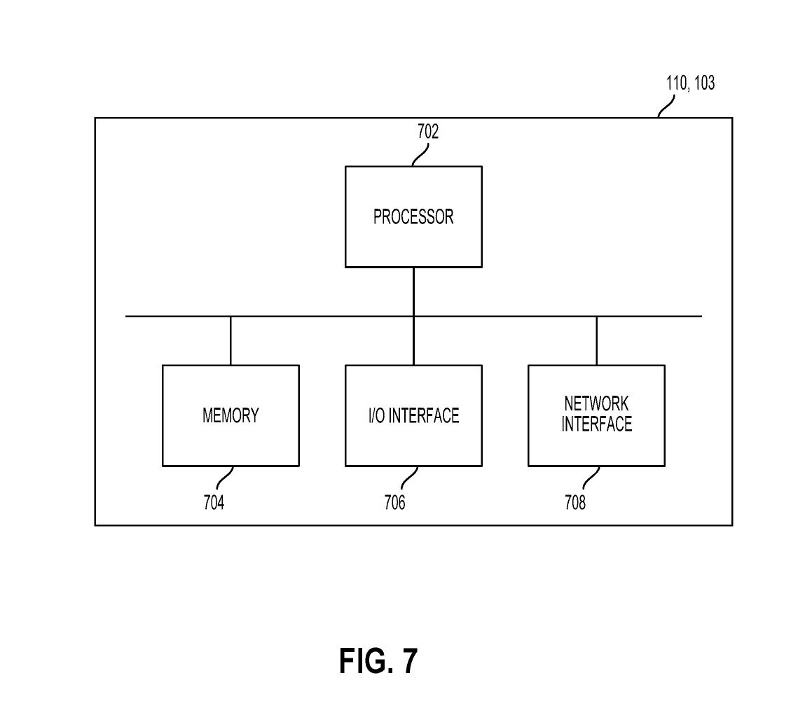

FIG. 7 is a schematic diagram of computing components that can implement aspects of user device 110 or the replicator 103 according to some embodiments and may be referred to generally as a computing device. The computing device includes at least one processor 702, memory 704, at least one I/O interface 706, and at least one network interface 708.

For simplicity only one computing device is shown but system may include more computing devices operable by users to access remote network resources and exchange data. The computing devices may be the same or different types of devices. The computing device components may be connected in various ways including directly coupled, indirectly coupled via a network, and distributed over a wide geographic area and connected via a network (which may be referred to as “cloud computing”).

For example, and without limitation, the computing device may connect to different components to exchange data such as a server, network appliance, set-top box, embedded device, computer expansion module, personal computer, laptop, personal data assistant, cellular telephone, smartphone device, UMPC tablets, video display terminal, gaming console, and wireless hypermedia device.

Each processor 702 may be, for example, any type of general-purpose microprocessor or microcontroller, a digital signal processing (DSP) processor, an integrated circuit, a field programmable gate array (FPGA), a reconfigurable processor, or any combination thereof.

Memory 704 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 706 enables computing device to interconnect with one or more input devices, such as a keyboard, mouse, camera, touch screen and a microphone, or with one or more output devices such as a display screen and a speaker.

Each network interface 708 enables computing device to communicate with other components, to exchange data with other components, to access and connect to network resources, to serve applications, and perform other computing applications by connecting to a network (or multiple networks) capable of carrying data.

Computing device is operable to register and authenticate users (using a login, unique identifier, and password for example) prior to providing access to applications, a local network, network resources, other networks and network security devices. Computing devices 100, 120 may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A media storage device comprising:
a distributed file system configured to write a plurality of private copies of a plurality of media files to a plurality of distributed storage servers, the distributed file system managing file and object metadata for the private copies of a plurality of media files; and
a processor configured to:
transmit, to a replicator, a replication request to create a private copy of a media file, the replication request specifying a convention for generating a reference for a copy of the media file of the plurality of copies of the media file;
receive, from the replicator, metadata indicating the reference for the private copy of the media file, the reference identifying a storage server of the plurality of distributed storage servers;
update the file and object metadata with the metadata indicating the reference for the private copy of the media file;
read the private copy of the media file from the storage server using the reference for the private copy of the media file of the file and object metadata; and
transmit the private copy of the media file to a user device for playout.

2. The media storage device of claim 1 further comprising a load balancer configured to monitor a plurality of replication requests and distribute the plurality of replication requests among a plurality of replicators to generate the plurality of private copies of the plurality of media files.

3. The media storage device of claim 1 wherein the replicator resides at the storage server of the set of distributed storage servers.

4. The media storage device of claim 3 wherein the processor is part of a central processing unit local to the storage server.

5. The media storage device of claim 3 wherein the processor is part of a media controller local to the storage server.

6. The media storage device of claim 1 wherein the media file comprises a plurality of file segments and wherein the replicator creates a copy of each of the plurality of file segments to create the private copy of the media file.

7. The media storage device of claim 1 wherein the media file comprises a first file segment and a second file segment, and wherein the processor is configured to create the private copy of the media file by transmitting the replication request to a first replicator to create a first copy of the first file segment and a second replicator to create a second copy of the second file segment.

8. A media storage device comprising:
a processor configuring a replicator to
read a media file;
create a private copy of the media file in response to a replication request, the replication request specifying a convention for generating a reference for the private copy of the media file;
write the private copy of the media file to a storage server of a plurality of distributed storage servers of a distributed file system;
generate the reference for the private copy of the media file based on the convention and the storage server; and
transmit metadata to the distributed file system, the metadata indicating the reference for the private copy of the media file.

9. The media storage device of claim 8 wherein the processor configures a plurality of replicators and a load balancer, the load balancer configured to monitor a plurality of replication requests and distribute the plurality of replication requests among the plurality of replicators to generate a plurality of private copies of the media file.

10. The media storage device of claim 8 wherein the processor is part of a central processing unit local to the storage server.

11. The media storage device of claim 8 wherein the processor is part of a microprocessor of a media controller for the storage server.

12. The media storage device of claim 8 wherein the media file comprises a plurality of file segments and wherein the replicator creates a copy of each of the plurality of file segments to create the private copy of the media file.

13. The media storage device of claim 8 wherein the media file comprises a first file segment and a second file segment, and the processor configures a first replicator to create a copy of the first file segment and a second replicator to create a copy of the second file segment.

14. The media storage device of claim 8 wherein the first replicator writes the copy of the first file segment to the storage server and the second replicator writes the copy of the second file segment to an additional storage server of the distributed storage servers.

15. The media storage device of claim 14 wherein the first replicator generates the metadata indicating the reference for the copy of the first file segment on the storage server and the second replicator generates the metadata indicating the reference for the copy of the second file segment on the additional storage server of the distributed storage servers.

16. A method for file storage comprising:
reading a media file from a distributed file system;
creating a plurality of private copies of the media file in response to a replication request, the replication request specifying a convention for generating a reference for each of the plurality of private copies of the media file;
writing the plurality of copies of the media file to a plurality of distributed storage servers of the distributed file system;
generating metadata indicating the reference for each of the plurality of copies of the media file based on the convention specified in the replication request and the plurality of distributed storage servers; and
transmitting the metadata to the distributed file system.

17. The method of claim 16 wherein reading the media file from the distributed file system comprises reading a plurality of file segments of the media file and wherein creating a plurality of private copies of the media file comprises creating a plurality of private copies of the plurality of file segments.

18. The method of claim 16 further comprising monitoring a plurality of replication requests and distributing the plurality of replication requests among the plurality of replicators.

19. The method of claim 16 wherein reading the media file from the distributed file system comprises reading a plurality of file segments of the media file and wherein creating a plurality of private copies of the media file comprises creating a plurality of private copies of a first file segment using a first replicator and creating a plurality of private copies of a second file segment using a second replicator.

20. The method of claim 13 further comprising transmitting a private copy of the media file from the storage server using the reference for the respective copy of the media file.

21. The method of claim 13 further comprising transmitting a plurality of replication requests to a plurality of replicators to create the plurality of private copies of the media file.

22. The method of claim 13 further comprising reading a private copy of the media file using the reference for the respective private copy of the media file.
